(19) United States
(12) Patent Application Publication
(10) Pub. No.: US 2005/0100715 A1
(43) Pub. Date: May 12, 2005

(54) Hygiene paper sheet and paper web of a plurality interconnected hygiene paper sheets

(75) Inventors: Gunnar Bredahl, Worms (DE); Gunther Zoller, Schriesheim (DE)

Correspondence Address: YOUNG & THOMPSON, 745 SOUTH 23RD STREET, 2ND FLOOR, ARLINGTON, VA, 22202, US

(73) Assignee: SCA HYGIENE PRODUCTS GMBH, MANNHEIM (DE)

(21) Appl. No.: 10/983,241

(22) Filed: Nov. 8, 2004

Related U.S. Application Data
(60) Provisional application No. 60/517,885, filed on Nov. 7, 2003.

(51) Int. Cl. B32B 23/02

(52) U.S. Cl. 428/192

(57) ABSTRACT

A hygiene paper sheet having a substantially rectangular basic shape with four edges, wherein each two edges thereof oppose each other in a parallel relationship. Corner points are formed at the intersection of each two of the four edges, having no parallel relationship. At least one of the edges is formed in a non-straight manner in an area defined between two corner points each of the two corner points being formed by the intersection of the at least one edge with a corresponding other edge. A plurality of interconnected hygiene paper sheets as described above may constitute a paper web.

### CROSS REFERENCE TO RELATED APPLICATION

This application claims the 35 U.S.C. §119(e) benefit of U.S. Provisional Application No. 60/517,885 filed on Nov. 7, 2003.

### FIELD OF THE INVENTION

The present invention relates to a hygiene paper sheet having a substantially rectangular basic shape with four edges, wherein each two edges thereof oppose each other in a parallel relationship. Corner points are formed at the intersection of each two of the four edges, having no parallel relationship. The invention further relates to a paper web being constituted by a plurality of interconnected hygiene paper sheets as described above.

For the purpose of this invention the term paper includes tissue paper, as well as non-woven.

A tissue paper is defined as a soft absorbent paper having a low basis weight. One generally selects a basis weight of 8 to 30 g/m², especially 10 to 25 g/m² per ply. The total basis weight of multiple-ply tissue products is preferably equal to a maximum of 65 g/m², more preferably to a maximum of 50 g/m². Its density is typically below 0.6 g/cm³, preferably below 0.30 g/cm³ and more preferably between 0.08 and 0.20 g/cm³.

The production of tissue is distinguished from paper production by its extremely low basis weight and its much higher tensile energy absorption index (see DIN EN 12625-4 and DIN EN 12625-5). Paper and tissue paper also differ in general with regard to the modulus of elasticity that characterizes the stress-strain properties of these planar products as a material parameter.

A tissue's high tensile energy absorption index results from the outer or inner creping. The former is produced by compression of the paper web adhering to a dry cylinder as a result of the action of a crepe doctor or in the latter instance as a result of a difference in speed between two wires (“fabrics”). This causes the still moist, plastically deformable paper web to be internally broken up by compression and shearing, thereby rendering it more stretchable under load than an uncreped paper.

Moist tissue paper webs are usually dried by the so-called Yankee drying, the through air drying (TAD) or the impulse drying method.

The fibers contained in the tissue paper are mainly cellulosic fibres, such as pulp fibers from chemical pulp (e.g. Kraft sulfite and sulfate pulps), mechanical pulp (e.g. ground wood), thermo mechanical pulp, chemo-mechanical pulp and/or chemo-thermo mechanical pulp (CTMP). Pulps derived from both deciduous (hardwood) and coniferous (softwood) can be used. The fibers may also be or include recycled fibers, which may contain any or all of the above categories. The fibers can be treated with additives—such as fillers, softeners, such as quaternary ammonium compounds and binders, such as conventional dry-strength agents or wet-strength agents used to facilitate the original paper making or to adjust the properties thereof. The tissue paper may also contain other types of fibers, e.g. regenerated cellulosic fibres or synthetic fibers enhancing, for instance, strength, absorption, smoothness or softness of the paper.

Tissue paper may be converted to the final tissue product in many ways, for example, by embossing or laminating it into a multi-ply product, rolled or folded.

By contrast, the term non-woven (ISO 9092, DIN EN 29092) is applied to a wide range of products which, in terms of their properties, are located between those of paper (cf. DIN 6730, May 1996) and cardboard (DIN 6730) on the one hand, and textiles on the other hand. As regards non-woven a large number of extremely varied production processes are used, such as the air-laid and spun-laced techniques as well as wet-laid techniques. The non-woven includes mats, non-woven fabrics and finished products made thereof. Non-wovens may also be called textile-like composite materials, which represent flexible porous fabrics that are not produced by the classic methods of weaving warp and weft or by looping. In fact, non-wovens are produced by intertwining, cohesive or adhesive bonding of fibres, or a combination thereof. The non-woven material can be formed of natural fibres, such as cellulose or cotton fibres, but can also consist of synthetic fibres, such as Polyethylene (PE), polypropylene (PP), polyurethane (PU), polyester, nylon or regenerated cellulose, or a mix of different fibres. The fibres may, for example, be present in the form of endless fibres of pre-fabricated fibres of a finite length, as synthetic fibres produced in situ, or in the form of staple fibres. The nonwovens according to the invention may thus consist of mixtures of synthetic and cellulose fibrous material, e.g. natural vegetable fibres (see ISO 9092, DIN EN 29092). The paper sheet of the present invention is preferably used in hygiene or wiping products. The term non-woven (ISO 9092, DIN EN 29092) is applied to a wide range of products which, in terms of their properties, are located between those of paper (cf. DIN 6730, May 1996) and cardboard (DIN 6730) on the one hand, and textiles on the other hand. As regards non-woven a large number of extremely varied production processes are used, such as the air-laid and spun-laced techniques as well as wet-laid techniques. The non-woven includes mats, non-woven fabrics and finished products made thereof. Non-wovens may also be called textile-like composite materials, which represent flexible porous fabrics that are not produced by the classic methods of weaving warp and weft or by looping. In fact, non-wovens are produced by intertwining, cohesive or adhesive bonding of fibres, or a combination thereof. The non-woven material can be formed of natural fibres, such as cellulose or cotton fibres, but can also consist of synthetic fibres, such as Polyethylene (PE), polypropylene (PP), polyurethane (PU), polyester, nylon or regenerated cellulose, or a mix of different fibres. The fibres may, for example, be present in the form of endless fibres of pre-fabricated fibres of a finite length, as synthetic fibres produced in situ, or in the form of staple fibres. The nonwovens according to the invention may thus consist of mixtures of synthetic and cellulose fibrous material, e.g. natural vegetable fibres (see ISO 9092, DIN EN 29092).

### BACKGROUND OF THE INVENTION

Hygiene paper sheets, such as handkerchiefs, facials, kitchen towels and toilet paper having a rectangular basic shape are generally known from daily life. More particular, all known sheet products or webs of a plurality of interconnected sheets available on the market have a uniform strictly rectangular shape.

The only features that vary are border embossing, coloring and imprinting, if present at all. In order to generate softness, conventionally physically active measures are taken, such as improvement of surface softness, crumpling softness, thickness feeling etc. In addition to these measures, optical features are introduced such as optimising printing, mass coloring, embossing and screen patterns. The reasons for these measures are to improve the visual impression of softness.

However, the paper sheet products create the optical impression of a stiff, board-type flat structure without any flexibility. Moreover, the overall appearance of the paper sheet product is uninviting.

As aforementioned the prior art suggests e.g. in handkerchiefs border embossing to improve the visual appearance and to produce plybonding. This border embossing is applied in a converting machine, e. g. according to a modified nested method, where the embossing naps of the steel roll insert into the recesses between the embossing naps of the counter roll. This results in a press contact at the nap faces with the nap base of the counter roll (DSE double soft embossing). In case e. g. of the double soft embossing, the embossing nap is run against a steel surface, which may cause considerable vibration and clear chatter marks due to the embossing frames positioned transverse to the machine direction on the embossing roll.

### SUMMARY OF THE INVENTION

Accordingly, the technical problem underlying the present invention is to provide a hygiene paper sheet or a paper web of a plurality of hygiene paper sheets having an improved appearance compared to the prior art, in particular with respect to its visual softness, as well as its visual attractiveness while still maintaining its desired properties for use, such as absorbability etc.

The aforementioned technical problem is solved by the subject matter defined in the independent claims. Further embodiments may be taken from the dependent claims.

In particular, the technical problem is solved by a hygiene paper sheet having a substantially rectangular basic shape with four edges, the intersection of two edges forming a corner point, wherein at least one edge is formed in a non-straight manner in an area defined between two corner points each of the two corner points being formed by the intersection of the at least one edge with a corresponding other edge. For the purpose of this invention, the passage “having a substantially rectangular basic shape” is to be understood as to be only the basic shape of the paper sheet, but not the actual shape. That is, the edges do not have to be straight and the corners may be broken, so that the uniform rectangular basic shape is broken and only virtually present.

The Applicant found that if at least one edge is formed in a non-straight manner in an area defined between two corner points, the strictly rectangular shape known from the prior art products is broken open so as to improve the appearance of the paper sheet regarding its visual softness and attractiveness. In particular, as the sharp edges of the paper sheet have been removed, it looks softer and more attractive than sheets having a uniform rectangular shape. In addition, in case e. g. of the double soft embossing, the vibration and clear chatter marks can be reduced.

Preferably, at least one corner located at one of the corner points is removed. In a preferred embodiment, the corner is rounded. Alternatively, the corner may also be chamfered, wherein the chamfer encloses preferably an angle of about 135° with each edge connected by the chamfer. In this context, the angle is constituted by the chamfer on the one hand and the virtual edge of the substantially rectangular basic shape intersecting with the chamfer.

Preferably, at least one edge of the hygiene paper sheet is curved in the area between the two corner points, wherein the at least one edge may be wave-shaped. Alternatively, the at least one edge could also be arc-shaped.

In a further embodiment, the at least one edge of the hygiene paper sheet is formed in a zigzag pattern in the area between the two corner points.

Preferably, at least two edges opposing each other a formed in the non-straight manner. In this context, the shape of opposing edges is complementary.

The present invention also suggests a paper web being constituted by a plurality of interconnected hygiene paper sheets as described above.

Preferably, the hygiene paper sheets are interconnected to each other by means of perforations, wherein the perforations are formed in the non-straight manner in the area between two corner points. Preferably, opposing edges of the hygiene paper sheets connected to the edges formed by the perforations are strait in an area between two corner points each of the two corner points being formed in the intersection of one of the two opposing edges with one of the edges formed by the perforations. As a result, when the paper web is rolled to form a cylindrical roll, the top and the bottom of the roll remain planar because of the straight edges, so as to improve the stackability and placeability. At the same time, when a user tears off a single hygiene paper sheet, the single sheet provide the inventive advantages.

A further object of the present invention is to provide a suitable method for manufacturing such products.

### BRIEF DESCRIPTION OF THE DRAWINGS

Further advantages and embodiments of the present invention will be more clearly understood from the following detailed description particularly when considered in conjunction with the accompanying drawings, in which like parts bear like reference numerals:

FIG. 1 shows a hygiene paper sheet according to the present invention.

FIG. 2 shows another hygiene paper sheet according to the present invention.

FIG. 3 shows a further hygiene paper sheet according to the present invention.

FIG. 4 shows a hygiene paper sheet according to the present invention in which the pattern of two opposing edges is complementary.

FIG. 5 shows a first method for manufacturing a hygiene paper sheet or a paper web according to the present invention.

FIG. 6 shows an alternative method for manufacturing a paper sheet or a paper web according to the present invention.

FIG. 7 shows a further alternative to the method shown in FIG. 6.

### DETAILED DESCRIPTION OF THE INVENTION

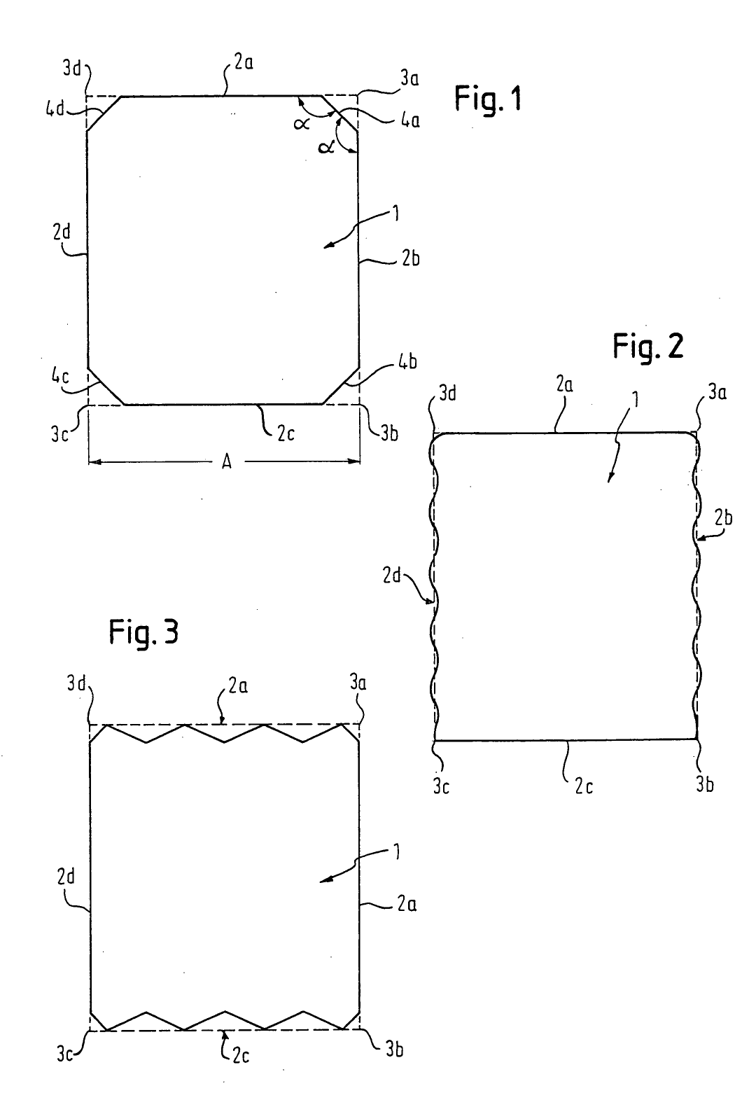

FIG. 1 shows a hygiene paper sheet 1 according to the present invention. The paper sheet 1 has a substantially rectangular basic shape indicated by the broken line. The rectangular basic shape has four edges 2a-d, each two edges 2a,b;2b,c;2c,d;2d,a form a corner point 3a-d at their intersection. Each two adjacent corner points 3a-d define an area A in between, as it is depicted in FIG. 1 only for corner points 3b and c (in the following reference is only made to this edge, though the other edges are equally formed). The edge 2c running between two adjacent corner points 3b,c and, thus, being located in the area A is formed in a non-straight manner. That is, the corner points 3b,c are not directly connected to each other by a straight edge or line, respectively. In fact, in the shown embodiment the corners conventionally formed by the connection of two edges (i.e. the corners formed at the corner points by the broken line) are removed so that the edge running between the corner points is chamfered before it actually reaches the corner point 3b and 3c, respectively. In the shown embodiment all four corners are removed, that is all four edges 2a-d are chamfered before they reach the respective corner points 3a-d. Preferably, the angle α between the chamfer 4a-d and the respective edge 2a-d to which the chamfer is connected is preferably 135°. However, the invention should not be limited to this angle. In fact, the angle between the chamfer 4a-d and one edge 2a-d to which the chamfer is connected and the angle between the chamfer 4a-d and the other edge 2a-d to which the chamfer is connected could also be different.

Turning now to FIG. 2, which shows a hygiene paper sheet 1 according to a further embodiment of the present invention. From this embodiment may be taken that the hygiene sheet 1 does not have to be formed symmetrical. In the shown embodiment, one 2d of the four edges 2a-d is formed in a straight manner within the area defined between two corner points 3b and c. However, the other three edges 2a,b,d are formed within the area defined between two adjacent corner points 3c,d;d,a;a,b in a non-straight manner. So, two opposing edges 2b,d are curved. In particular, these two edges 2b,d are wave-shaped. In addition, the corners formed between the two opposing edges 2b,d and one 2a of the two other edges 2a,c are removed, namely rounded. Consequently, also this third edge 2a is formed in a non-straight manner between two adjacent corner points 3d,a, because the edge 2a does not completely extend between the two corner points 3d,a. More particularly the part at which the edge 2a is arched (near the corner points 3d,a), it does not coincide with the visual edge of the substantially rectangular basic shape indicated by the broken line.

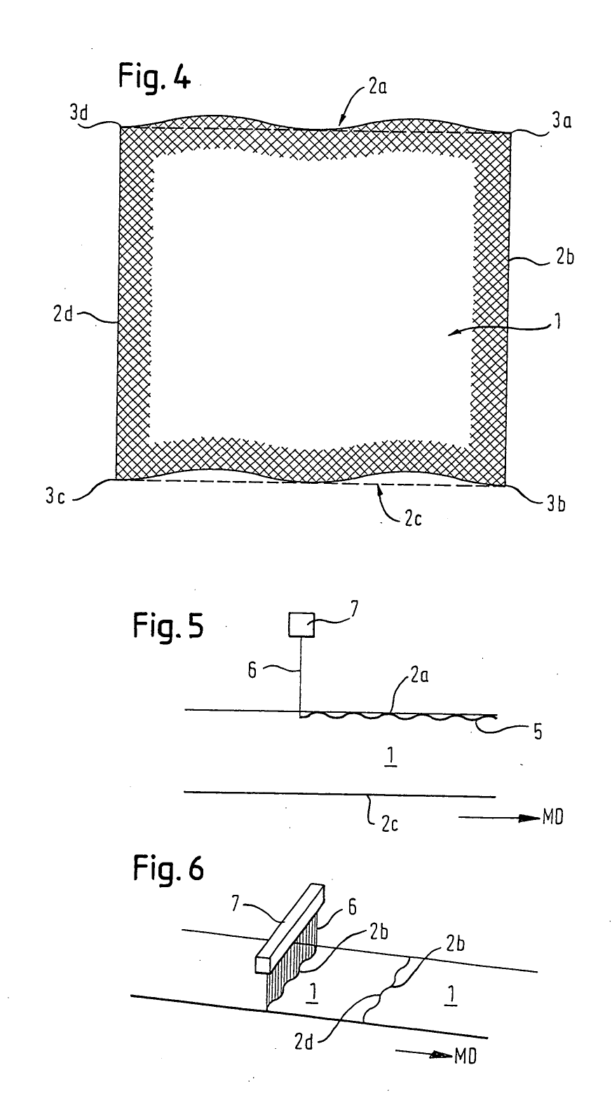

In FIG. 3, two opposing edges 2a,c are formed in a zigzag pattern, whereas the other opposing edges 2b,d are chamfered in the vicinity of fictious corner points 3a-d. A further embodiment is shown in FIG. 4. In this embodiment, the hygiene paper sheet 1 has two opposed edges 2a,c formed in a wave-shape. It is apparent that these wave shapes are complementary. This can be best achieved by producing the hygiene paper sheet 1 from a web, wherein the opposed edges are crosswise to a machine direction (MD) in which the paper web runs. In particular, the paper web is cut transverse to the machine direction so that concurrently the same, but complementary cut is formed on two opposed edges of two subsequent paper sheets of the paper web. The methof of manufacture is described in more detail below.

When at least two opposed edges are formed in a non-straight manner, that is the straight-lines of the substantially rectangular basic shape are broken, the hygiene paper sheet will be provided with an visual appearance that gives the impression of depth similar to that of soft textile material. In addition, to the formed cut, the hygiene paper sheet may be border embossed or printed as it is known in the art.

Further, the border embossing within the area between two corner points in which the edge is formed in a non-straight manner may have a different width to reinforce perspective impression of depths.

The cut of the at least one edge in a non-straight manner may be technically realized by the so-called laser cut technology described below. A similar method is also known from EP 1 305 132. In contrast, the most prior art cutting devices are only suitable to produce straight line cuts.

Turning now to the method for manufacturing of hygiene paper sheets according to the present invention or a hygiene paper web being constituted by a plurality of hygiene paper sheets according to the present invention.

In FIG. 5 a device for cutting the edge of a paper web in a longitudinal direction, that is in parallel to the machine direction (MD) is schematically shown. In such a device a paper web is running with high speed in the machine direction (MD). At a later stage, the web is cut into a plurality of hygiene paper sheets 1 or perforated and rolled so as to provide a hygiene paper web being constituted of a plurality of hygiene paper sheets being interconnected to each other by means of perforations. A laser source 7 is located above one or both of the longitudinal edges 2a,c (with reference to FIG. 1 to 4 the edges could also be indicated 2b,d) of the paper web. The laser source 7 is movable, so that the laser beam 6 moves transverse to the direction of movement of the web so as to cut the edge 2a into pattern, e.g. a wave pattern 5 as shown in FIG. 5. Thus, the longitudinal edge 2a or both longitudinal edges 2a,c of the paper web are cut into a wave shape.

In FIG. 6 a further method is shown. Compared to the one shown in FIG. 5 this device enables to conduct a complete cross cut through a web transverse to the machine direction.

In fact, such a device enables to provide a kind of a laser curtain across the whole paper web, so as to enable a cross cut or a cross perforation. Such a laser curtain can be achieved in different ways.

Firstly, a specific number of lasers can be set in a parallel manner, wherein the lasers are preferably arranged so as to form the pattern of the non-straight edge 2. In other words, the laser source 7 is constituted by a plurality of single laser sources set in a row, which are controlled by one common means.

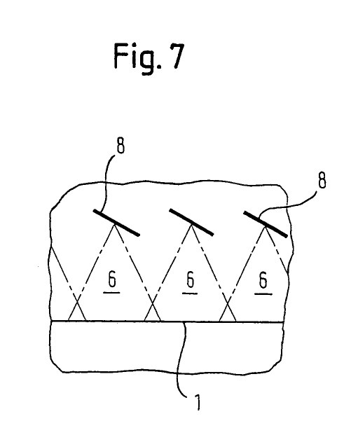

A further possibility would be a row of laser sources which are controlled by mirrors 8. In this context, the mirrors 8 could oscillate with the same frequency so that a specific area could be energized by the different laser beams. If a continuous paper web being constituted of a plurality of interconnected hygiene paper sheets is to be produced, a plurality of cuts are conducted side by side across the paper web so as to form a perforation. The perforation is preferably formed in the non-straight manner, whereas the longitudinal edges of the paper web remain substantially straight. In this way, if the hygiene paper web is distributed in the form of a roll, the strait longitudinal edges form a substantially flat bottom and top of the cylindrical roll, whereas the perforated edges in the non-straight manner improve visual appearance and softness. If a complete cut is to be performed, the areas of laser activation 6 overlap as shown in FIG. 7. Alternatively to the above-named manufacturing method, the oscillating mirrors could be fixed mirrors disposed in a row, which need to be so close, that the perforated cut is created. In this context, the mirrors are semi-transparent so as to only divert a part of the laser beam energy so that the rest of the energy could be used by the subsequent mirrors.

1. Hygiene paper sheet having a substantially rectangular basic shape with four edges, the intersection of two edges forming a corner point, wherein at least one edge is formed in a non-straight manner in an area defined between two corner points each of the two corner points being formed by the intersection of the at least one edge with a corresponding other edge.

2. Hygiene paper sheet according to claim 1, wherein the at least one edge is formed so that a corner at least one of the corner points is removed.

3. Hygiene paper sheet according to claim 2, the corner is rounded.

4. Hygiene paper sheet according to claim 2, the corner is chamfered.

5. Hygiene paper sheet according to claim 4, wherein the chamfer encloses an angle of about 135° with each edge connected by the chamfer.

6. Hygiene paper sheet according to claim 1, wherein the at least one edge is curved in the area between the two corner points.

7. Hygiene paper sheet according to claim 6, wherein the at least one edge is wave-shaped.

8. Hygiene paper sheet according to claim 6, wherein the at least one edge is arc-shaped.

9. Hygiene paper sheet according to claim 1, wherein the at least one edge is formed in a zigzag pattern in the area between the two corner points.

10. Hygiene paper sheet according to claim 1, wherein at least two edges opposing each other are formed in the non-straight manner, the shape of one of the opposing edges being complementary to the shape of the other one of the opposing edges.

11. Paper web being constituted by a plurality of interconnected hygiene paper sheets according to claim 1.

12. Paper web according to claim 11, wherein the hygiene paper sheets are interconnected to each other by perforations, which are formed in a non-straight manner in the area between the two corner points.

13. Paper web according to claim 12, wherein opposing edges of the hygiene paper sheets connected to the edges formed by the perforations are straight in an area between two corner points, each of the two corner points being formed by the intersection of one of the two opposing edges with one of the edges formed by the perforations.

14. Method for manufacturing a hygiene paper web, the method comprising the steps of:
transporting the web in a machine direction; and
cutting at least one longitudinal edge of the paper web in a non-straight manner with a laser source.

15. Method according to claim 14, the method further comprising the step of perforating the paper web transverse to the machine direction in a straight or a non-straight manner with a laser source.

16. Method for manufacturing a hygiene paper sheet according to claim 1 comprising the steps of:
transporting a paper web in a machine direction;
cutting at least one longitudinal edge of the paper web in a non-straight manner with a laser source; and
cutting the paper web into a plurality of hygiene paper sheets or cutting the paper web transverse to the machine direction in a non-straight manner with a laser source into a plurality of hygiene paper sheets.
